(19) United States
(12) Patent Application Publication
(10) Pub. No.: US 2025/0021063 A1
(43) Pub. Date: Jan. 16, 2025

(54) Computer-Implemented Method for Operating a Technical Device Using a Model

(71) Applicant: Siemens Aktiengesellschaft, Muenchen (DE)

(72) Inventors: Safoura REZAPOUR LAKANI, Wien (AT); Thomas BLUMAUER-HIEßL, Wien (AT); Sebastian MEIXNER, Wien (AT); Daniel SCHALL, Hollabrunn (AT)

(21) Appl. No.: 18/711,992

(22) PCT Filed: Nov. 21, 2022
(86) PCT No.: PCT/EP2022/082634

§ 371 Date: May 21, 2024

(30) Foreign Application Priority Data
Nov. 23, 2021 (EP) 21209837

(51) Int. Cl. G05B 13/04; G05B 13/02

(52) U.S. Cl. CPC G05B 13/048; G05B 13/0265

(57) ABSTRACT

A computer-implemented method for operating a technical device via a model, wherein a) clients having a respective technical device are acquired, b) the clients are grouped into first and second groups through comparison with a respectively predetermined range of values for the respective group, c), d) a first and second group models for the first and second groups are trained and provided to a server, respectively, e) the first and the second group models are received and aggregated via the server and a global model having global model parameters is formed from the first and second group models, f) the global model is transmitted to a client and the technical device is operated via the global model, where the latency of the clients is also acquired in a) and the clients are grouped in b) based on their respective latency.

### CROSS-REFERENCE TO RELATED APPLICATIONS

This is a U.S. national stage of application No. PCT/EP2022/082634 filed 21 Nov. 2022. Priority is claimed on European Application No. 21209837.0 filed 23 Nov. 2021, the content of which is incorporated herein by reference in its entirety.

### BACKGROUND OF THE INVENTION

### 1. Field of the Invention

The invention relates to a computer program, an electronically readable data carrier, a data carrier signal and a computer-implemented method and a system for operating a technical device using a model.

### 2. Description of the Related Art

Machine learning (ML) is frequently used nowadays in industrial applications.

Machine learning can be used, for example, for object classification to identify a groove in a semiconductor wafer in a metal workpiece in order to assess whether the groove is correctly placed.

Machine learning can also be used for operating state monitoring to determine, for example, whether a pump is running or stopped.

ML can also be used for anomaly detection.

As several production sites may require the same ML application, such as pump state monitoring, the training of a model based on aggregated data from all the available pumps, even if they are located at different sites, can result in a better ML model overall.

However, data sharing between customers is not always possible due to privacy concerns or the volume of data.

Federated learning (FL) can therefore be used to aggregate knowledge between a plurality of clients and to train a model between them without sharing data.

However, the clients may have different latencies in their communication or computing apparatus by which they are connected to each other or to a server.

This can result in undesirable effects in training an ML model, especially if the latency is hours or even days, for example, due to a temporary disconnection.

In the prior art, “synchronous FL” is used to aggregate knowledge between clients, but clients with higher latencies of hours or days can unacceptably increase the training time.

Alternatively, discarding slow clients in FL can improve training time but also degrade performance, because the discarded clients may contribute more positively to an accurate model.

Latency-aware FL algorithms can group clients with the same latency profile prior to training. However, in many cases, latency conditions change dynamically during training and require an automatic trigger in order to identify when regrouping should be performed.

Moreover, grouping clients independently of their data distribution may not work optimally for non-iid data (i.e., data that is not independently and identically distributed), where each client may have different data.

In the publication Chai Zheng et al. “FedAT: a high-performance and communication-efficient federated learning system with asynchronous tiers”, XP055921917, a system is described that asynchronously aggregates a model of a plurality of clients. The aggregation and the relevant communication requirements are discussed in general terms, without going into detail about individual, possibly changing, i.e., dynamic client behavior.

In the publication Chai Zheng et al. “TiFL: A Tier-based Federated Learning System”, XP058460367, a system is described that asynchronously aggregates a model of a plurality of clients. The aggregation and the relevant communication requirements are discussed in general terms, and the clients are divided into groups with similar latency behavior without going into individual, possibly changing, i.e., dynamic client behavior in more detail.

### SUMMARY OF THE INVENTION

It is an object of the invention to provide a solution for applications based on federated learning, where the solution dynamically addresses in particular the latency between clients or servers and thus improves both the training time and the characteristics of the ML model, resulting in faster and more accurate ML models for clients or simplifying the generation thereof, thereby enabling them to make a better contribution to a common model in each case.

This and other objects and advantages are achieved in accordance with the invention by a method comprising:
a) acquiring (registering) clients having a particular technical device,
b) grouping the clients into a first group and at least one second group by comparison with a respectively predetermined value range for the particular group,
c) training a first group model for the first group by at least one client assigned to the first group, and providing the first group model to a server,
d) training a second group model for the at least one second group by at least one client assigned to the at least one second group, and providing the second group model to the server,
e) receiving and aggregating the first and second group models by the server and creating a global model with global model parameters from the first and second group models, and
f) transmitting the global model to a client and operating the technical device using the global model.

In accordance with the inventive method, the latency of the clients is also acquired in step a) and the clients are grouped in step b) on the basis of their respective latency.

In addition, it is particularly advantageous if the latency of the clients optionally includes a latency profile for the respective client, where the profile contains at least two latency values for different operating states of the client or of the connected technical device.

Latency-aware federated learning in accordance with the invention, which adaptively groups clients based on their latency and optionally also their contribution taking into account the data distribution of the clients, can improve both performance and training time.

For example, ML/FL models can be represented and transmitted by model parameters.

It is advantageous if three, four, five or ten groups and group models are used in order to be able to take individual latency differences of clients into account in a particularly sensitive manner, especially if a weighting of the individual clients is also to be taken into account.

Clients with non-iid data distribution can cause the accuracy of the FL model to be reduced at the aggregation stage. This can be improved by combining similar clients into a common group, which can result in a positive transfer of knowledge between the clients and thus in improved accuracy.

A latency profile can be used to obtain a plurality of latency values for a client or connected devices, thereby enabling the accuracy of the model to be improved, especially for dynamic changes in a latency profile.

If the latency profile of a client changes during training, for example, if the client receives a new task that adversely affects its computing capacity, or if a client is no longer available, then the predictions and estimates of the groups must be adjusted and corrected.

A change in latency during the operation of a client can be designated as dynamic client behavior and can be described in more detail by operating states. As a result, two or more models are provided for a client to map the dynamic behavior accordingly.

Consequently, individual clients can each have models for two or more latency values and these models can be assigned to different groups of clients. A client can therefore be represented in different client groups, but with different latency values, i.e., models or profiles.

Corresponding operating states, such as commissioning, a high or low task or resource load, good or poor connection quality or an operating state dependent on an operating time, can be used to achieve a “individualization” or “personalization” for the model that is particularly accurate for the respective operating states.

In addition, it is possible to acquire the two or more latency values in their combination in a group to obtain a global model that is as accurate as possible for a plurality of operating states between which it is possible to switch quickly.

A favorable choice of group assignment criteria based on respective latencies and client contributions can, for example, mean that fast clients with high model accuracy distributions will contribute more to the FL model and consequently the accuracy of the global model will be improved.

It also means that clients, even those that do not contribute to a global model, can call up and apply an accurate model.

This is particularly useful, for example, when new clients for which no training data is yet available are put into operation.

In an embodiment of the invention, the global model contains at least two latency values for different operating states.

In addition, in another embodiment of the invention, a group model contains at least two latency values for different operating states.

In a further embodiment of the invention, step b) and steps c) and/or d) are repeated and the respective group model is re-determined, and steps e) and f) are again performed. This achieves dynamic grouping, which advantageously means that the global model is always up-to-date and therefore particularly accurate, especially in specific operating situations.

This is particularly advantageous because it also ensures that clients are assigned to the correct, i.e., most similar, group and are not permanently in an unfavorable group due to a temporary unfavorable situation.

Such an unfavorable temporary effect can occur, for example, if the processor of the client is briefly occupied with a compute-intensive secondary task causing poorer latency behavior for FL training during this period.

The situation can also arise that some clients contribute more to a model and thus improve the accuracy. It is therefore advantageous if these clients are also used more intensively for other FL training processes in order to improve their models also.

Accordingly, dynamic grouping based on latency and contribution profiles of clients improves model accuracy during training and ensures optimal training times.

In a further embodiment of the invention, steps b) to d) are repeated at a predetermined time interval, such as after 30 minutes. This results in a particularly simple implementation of dynamic grouping.

In a further embodiment of the invention, steps b) to d) are repeated after a predetermined number of communications for receiving between a client and the server in step e), such as after 20 communication rounds. This provides an additional embodiment for particularly simple implementation of dynamic grouping.

In another embodiment of the invention, steps b) to d) are repeated after a predetermined threshold latency value of the client has been exceeded. This provides an additional embodiment for particularly rapid implementation of dynamic grouping.

In a still further embodiment of the invention, steps b) to d) are repeated upon determining that the model accuracy of the first and/or second group model is decreased compared to the model accuracy of the global model. For dynamic grouping, this ensures that incorrect data, for example, can be detected quickly and thus an undesirable effect on the model can be promptly prevented.

The model accuracy can be determined, for example, by using a confusion matrix in which predicted values are compared with actual values.

In an embodiment of the invention, the predetermined value ranges for the respective group are determined automatically and steps a) to f) are rerun. This provides a particularly simple way of performing dynamic grouping by implementing a value range adjustment, for example, using a newly determined average range value.

In a further embodiment of the invention, grouping is performed in step b) by also taking into account, for each client, a predetermined contribution factor s that describes a weighting of the contribution of a respective client for a group, which is preferably determined in accordance with the relationship:

$${S}_{G} = \frac{1}{{N}_{{K}_{G}}} {\sum }_{\{ k ∈ {G}_{K} \}} α \cdot \frac{1}{{L}_{k}} + β \cdot {b}_{k}$$

where
α, β . . . represent training hyperparameters,
K_{G} . . . represents a client group,
N_{K}_{_{G}} . . . represents a number of clients within a group,
Lₖ . . . represents the latency of a client, and
bₖ . . . represents the contribution of a client.

A hyperparameter is a parameter whose value is used to control the learning process, while the values of other parameters are derived through training.

This means that, in addition to latency, a weighting of individual clients can be taken into account to involve, for example, particularly significant or trustworthy clients more heavily in model generation.

The combination of latency behavior and contribution factor of clients can result in particularly good model characteristics.

The contribution factor s can be determined after each communication round, for example. A group can be selected, for example, based on the probability distribution of the contribution factor s.

Each group can therefore have a contribution factor s that is based on a probability distribution and that links the latency to the contribution. Thus, groups with low latency and a higher contribution can be coded with a higher contribution factor s.

The probability distribution can be determined in accordance with the following relationship:

$$p r o {b}_{G} = \frac{{S}_{G}}{Σ \{ g ∈ G \} {S}_{g}}$$

This means that the probability distribution of the contribution factor s corresponds to the probability for all the groups. By sampling the probability distribution, groups with faster clients, i.e., with lower latency, and higher model contribution are selected with a higher probability. This is advantageous, because the aim is to achieve faster FL training with a simultaneously accurate model.

In a further embodiment of the invention, the global model contains at least two latency values for different operating states.

The above-mentioned method enables results to be retrieved after just a few communication rounds, since fast clients involved in the federated learning have already provided sufficient contributions to the global model.

The objects and advantages in accordance with the invention are also achieved by a system comprising clients that each have a client processor and a client memory and a connected technical device, a control apparatus with a control processor and a control memory and a server, where the system implements the method in accordance with the disclosed embodiments.

The objects and advantages in accordance with the invention are also achieved by a computer program comprising commands which, when executed by a computer, cause the computer to performed the method in accordance with the disclosed embodiments of the invention.

The objects and advantages in accordance with the invention are also achieved by an electrically readable data carrier with readable control information stored thereon which comprises at least the computer program in accordance with the invention and which is configured such that, when the data carrier is used in a computing facility, it implements the method in accordance with the disclosed embodiments of the invention.

The objects and advantages in accordance with the invention are also achieved by a data carrier signal that transmits the computer program in accordance with the invention.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The invention will now be explained in more detail with reference to an exemplary embodiment shown in the accompanying drawings, in which:

FIG. 1 shows a flow diagram for an exemplary embodiment of the invention; and

FIG. 2 shows an exemplary flowchart of the method in accordance with and embodiment of the invention.

### DETAILED DESCRIPTION OF THE EXEMPLARY EMBODIMENTS

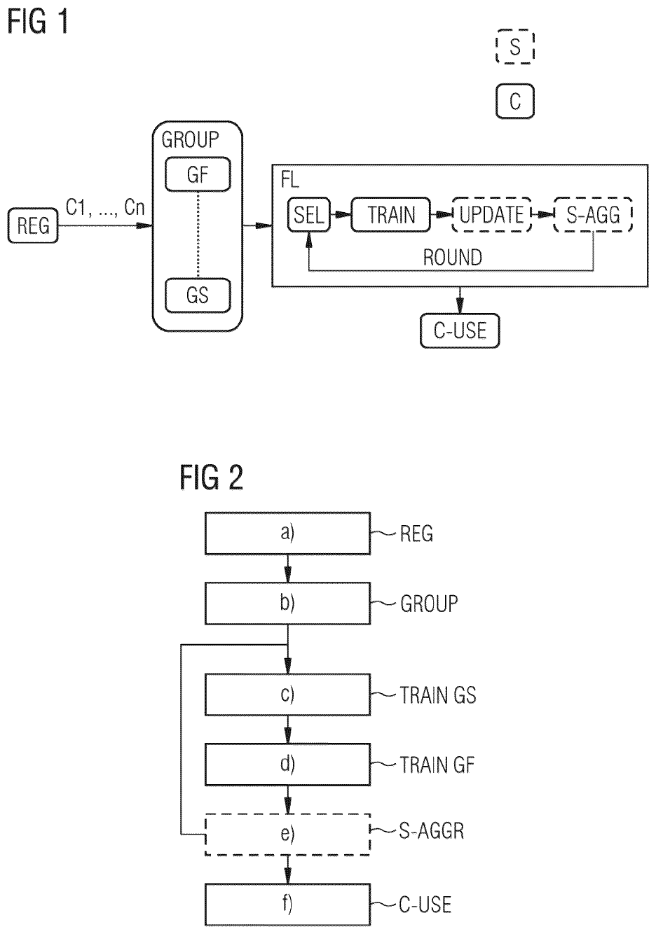

FIG. 1 shows an exemplary embodiment of the invention for a computer-implemented method in which a plurality of federated learning (FL) clients participate in a joint federated learning FL process, contribute to a common model and improve the common model.

The method is used to operate a technical device with a particularly accurate model.

Method steps bordered with dashed lines in the figure are performed by a server S, method steps bordered with solid lines are performed by a client C.

With the proposed approach, the training of the model is not limited to the data set an individual client, but the model can also benefit from other clients without sharing its own data directly. In other words, privacy is additionally protected.

First, the clients C1-Cn register in a registration step REG to participate in the federated learning FL of clients.

The server transmits a stored global model from previous trainings processes to the clients C1-Cn. The federated learning involves a plurality of communication rounds, i.e., a new global model is iteratively generated that is in turn distributed to the clients where it is trained again by the respective client using its own training data and made available to the server for aggregation using the model parameters, such as weights in a neural network. The server receives the data from all the clients, aggregates the data and updates the global model accordingly.

In order to federate efficiently among clients with different latencies, prior to the FL training, a client receives a small task in which latency profiles are determined. Initially, they are assigned to fast and slow groups based solely on their latency, where each group has a maximum latency or latency value range.

After each communication or iteration round, a group is selected and the clients within this selected group are aggregated. The server acquires model updates within a predefined waiting time for the group. If a client does not respond as intended, for example, due to an interrupted connection, then the client is not taken into account.

This is followed by grouping GROUP of the registered clients into a group of fast clients GF and a group of slow clients GS, where a fast client is grouped with similar clients based on associated latency values within predefined range limits. Accordingly, a slow client is grouped into a different group with other predefined range limits. It is clear that there may be other client groups with similar latency values.

Federated learning FL then occurs. This involves the selection SEL of a latency group and the individual training TRAIN of an ML model within a latency group GF, GS by the assigned client.

In a parameter updating step UPDATE, the assigned client provides the local model parameters of the generated ML model to the server for further processing.

From the local parameters received from the client, the server aggregates the local parameters into a global model with global model parameters in a step S-AGGR.

If necessary, this determination of global ML parameters is repeated in further parameter updating rounds ROUND and the global model is re-determined with global model parameters.

When required, a client now downloads the global aggregated ML model for further use for operating a technical device, for example, to predict optimal maintenance intervals.

In summary, the following steps are performed:
a) acquisition/registering of clients C1-Cn having a respective technical device, and also of the latency of the clients C1-Cn,
b) grouping GROUP of the clients C1-Cn into a first group GS and a second group GF based on their respective latency by comparison with a predetermined range of values for the respective group GS, GF,
c) training TRAIN of a first group model for the first group GS by at least one client that is assigned to the first group GS, and providing UPDATE the first group model to a server,
d) training TRAIN of a second group model for the second group GF by at least one client assigned to the second group GF and providing UPDATE the second group model to the server,
e) receiving and aggregation S-AGGR of the first and second group models by the server and creation of a global model with global model parameters from the first and second group models, and
f) transmitting the global model to a client and operating the technical device using the global model.

Step b) and steps c) and/or d) can optionally be repeated, where the respective group model is then re-determined and steps e) and f) are executed again.

Steps b) to d) can, for example, be repeated at a predetermined time interval.

Alternatively, steps b) to d) can be repeated, for example, after a predetermined number of communications for receiving between a client and the server in step e).

Steps b) to d) can also be repeated, for example, after a predetermined latency threshold value of a client a has been exceeded.

Steps b) to d) can also be repeated, for example, upon determining that the model accuracy of the first and/or second group model is reduced compared to the model accuracy of the global model.

The global model can contain at least two latency values for different operating states, for example, a high or low task or resource load, a good or poor connection quality.

This can also be advantageous if a machine is used to manufacture different products between which it is possible to switch quickly and easily in a dynamic manner.

Alternatively, the two or more operating states can be dependent on an operating time, as an “individualization” or “personalization” for the model.

It is also possible to acquire the two or more latency values in their combination in a group in order to obtain a global model that is as accurate as possible for a plurality of operating states between which it is possible to switch quickly.

The respective group model can contain at least two latency values for different operating states.

The model accuracy can be determined, for example, by comparing output values predicted by the FL model with actual output values of a technical device of a client.

The predetermined value ranges for the first and second groups GS, GF can, for example, be dynamically redefined and steps a) to f) can be repeated.

The grouping in step b) can be performed for example by also taking into account, for each client, a predetermined contribution factor s which describes a weighting of the contribution of a respective client for a group, where the factor is preferably determined in accordance with the relationship:

$${S}_{G} = \frac{1}{{N}_{{K}_{G}}} {\sum }_{\{ K ∈ {G}_{K} \}} α \cdot \frac{1}{{L}_{K}} + β \cdot {b}_{K}$$

where
α, β . . . represent training hyperparameters,
K_{G} . . . represents a client group,
N_{K}_{_{G}} . . . represents the number of clients within a group,
L_{K} . . . represents latency of the client, and
b_{K} . . . represents contribution of the client.

The latency of the clients (C1-Cn) can, for example, include a latency profile for the respective client (C1-Cn), containing at least two latency values for different operating states of the technical device connected to the client.

The technical device of a client can be operated using an ML model, for example, by predicting maintenance intervals by applying the ML model.

It is clear that the models used for the clients' technical devices can only be jointly aggregated if the devices are mutually conformal, i.e. are of similar design.

FIG. 2 shows a flow diagram of an exemplary embodiment of the method in accordance with the invention.

The explanations relating to the previous figure apply equally to the illustrated method steps.

Thus, while there have been shown, described and pointed out fundamental novel features of the invention as applied to a preferred embodiment thereof, it will be understood that various omissions and substitutions and changes in the form and details of the methods described and the devices illustrated, and in their operation, may be made by those skilled in the art without departing from the spirit of the invention. For example, it is expressly intended that all combinations of those elements and/or method steps that perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-14. (canceled)

15. A computer-implemented method for operating a technical device utilizing a model, the method comprising:
a) acquiring clients having a respective technical device;
b) grouping the acquired clients into a first group and at least one second group by comparison with a respectively predetermined range of values for a respective group;
c) training a first group model for the first group by at least one client which is assigned to the first group, and providing the first group model to a server;
d) training a second group model for the at least one second group by at least one client which is assigned to the at least one second group, and providing the second group model to the server;
e) receiving and aggregating the first and second group models by the server and creating a global model with global model parameters from the first and second group models; and
f) transmitting the global model to a client and operating the technical device utilizing the created global model;
wherein latency of the clients is also acquired in step a) and the clients are grouped in step b) based on their respective latency; and
wherein the latency of the clients comprises a latency profile for a respective client, said profile comprising at least two latency values for different operating states of the technical device connected to the client.

16. The method as claimed in claim 15, wherein at least one of step b), step c) and d) is repeated and a respective group model is re-determined, and steps e) and f) are re-performed.

17. The method as claimed in claim 16, wherein steps b) to d) are repeated at a predetermined time interval.

18. The method as claimed in claim 16, wherein steps b) to d) are repeated after a predetermined number of communications for receiving between a client and the server in step e).

19. The method as claimed in claim 16, wherein steps b) to d) are repeated after a predetermined latency threshold for a client is exceeded.

20. The method as claimed in claim 15, wherein steps b) to d) are repeated upon determining that a model accuracy of at least one of the first group model and the second group model is reduced compared to a model accuracy of the global model.

21. The method as claimed in claim 15, wherein the global model includes at least two latency values for different operating states.

22. The method as claimed in claim 15, wherein the respective group model includes at least two latency values for different operating states.

23. The method as claimed in claim 15, wherein predetermined value ranges for the respective group are redefined and steps a) to f) are again performed.

24. The method as claimed in claim 15, wherein grouping is performed in step b) by additionally taking into account a predetermined contribution factor(s) for each client, said predetermined contribution factor(s) describing a weighting of a contribution of a respective client for a group, which is determined in accordance with the relationship:
$${S}_{G} = \frac{1}{{N}_{{K}_{G}}} {\sum }_{\{ K ∈ {G}_{K} \}} α \cdot \frac{1}{{L}_{K}} + β \cdot {b}_{K}$$
where
α, β . . . represent training hyperparameters,
K_{G} . . . represents a client group,
N_{K}_{_{G}} . . . represents a number of clients within the group,
L_{K} . . . represents latency of the client, and
b_{K} . . . represents contribution of the client.

25. A system for operating a technical device utilizing a model, the system comprising:
a plurality of clients, each of the plurality of clients having a client processor and a client memory and each having a connected technical device;
a control apparatus including a control processor and a control memory and a server;
wherein the system is configured to:
b) acquire clients having a respective technical device;
b) group the acquired clients into a first group and at least one second group by comparison with a respectively predetermined range of values for a respective group;
c) train a first group model for the first group by at least one client which is assigned to the first group, and provide the first group model to a server;
d) train a second group model for the at least one second group by at least one client which is assigned to the at least one second group, and provide the second group model to the server;
e) receive and aggregate the first and second group models by the server and create a global model with global model parameters from the first and second group models; and
f) transmit the global model to a client and operate the technical device utilizing the created global model;
wherein latency of the clients is also acquired in step a) and the clients are grouped in step b) based on their respective latency; and
wherein the latency of the clients comprises a latency profile for a respective client, said profile comprising at least two latency values for different operating states of the technical device connected to the client.

26. A computer program comprising commands which, when executed by a computer, cause the computer to perform the method as claimed in claim 15.

27. An non-transitory electronically readable data carrier encoded with readable control information stored thereon which includes at least a computer program which, when executed in a computing facility, causes operation of a technical device utilizing a model, the computer program comprising:
a) program code for acquiring clients having a respective technical device;
b) program code for grouping the acquired clients into a first group and at least one second group by comparison with a respectively predetermined range of values for a respective group;
c) program code for training a first group model for the first group by at least one client which is assigned to the first group, and providing the first group model to a server;
d) program code for training a second group model for the at least one second group by at least one client which is assigned to the at least one second group, and providing the second group model to the server;
e) program code for receiving and aggregating the first and second group models by the server and creating a global model with global model parameters from the first and second group models; and
f) program code for transmitting the global model to a client and operating the technical device utilizing the created global model;
wherein latency of the clients is also acquired in step a) and the clients are grouped in step b) based on their respective latency; and
wherein the latency of the clients comprises a latency profile for a respective client, said profile comprising at least two latency values for different operating states of the technical device connected to the client.

28. A data carrier signal which transmits the computer program as claimed in claim 26.
